(19) United States
(12) Patent Application Publication
(10) Pub. No.: US 2020/0406447 A1
(43) Pub. Date: Dec. 31, 2020

(54) RAIL TYPE TOOL RACK

(71) Applicant: Chih-Chien HSIEH, Taichung City (TW)

(72) Inventor: Chih-Chien HSIEH, Taichung City (TW)

(21) Appl. No.: 16/898,986

(22) Filed: Jun. 11, 2020

(30) Foreign Application Priority Data
Jun. 27, 2019 (TW) 108122578

(51) Int. Cl. B25H 3/04

(52) U.S. Cl. CPC B25H 3/04

(57) ABSTRACT

Disclosed is a tool rack having a track, at least one tool positioning seat and two combined end covers. The track has an intermediate plate, two lateral grooves and two ends. Each lateral groove forms two side wall edges and one side opening, and the intermediate plate is respectively provided with a through hole at a position adjacent to each end. Each combined end cover includes a main body, one end limit block, two side claws and a bump. The main body has two lateral sides and one end side, and an abutting surface used for abutting against an outer wall surface of one side wall edge of the track. The end limit block abuts on the end of the track. The two side claws are respectively gripped and positioned outside the side wall edge of the track, and the bump is embedded in the through hole.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a rack for tools, and more particularly to the innovative structure type of a rail type tool rack.

### 2. Description of Related Art Including Information Disclosed Under 37 CFR 1.97 and 37 CFR 1.98.

Said rail type tool rack is generally used as a holder for placing such tools as sleeves and screwdrivers. Its structure design is characterized by a long extended railroad shoe, and the railroad shoe is provided with an embedded slideway for slideable adjustment of several tool positioning seats, and the two opposite ends of railroad shoe are usually provided with end covers to close the two ends of railroad shoe, and to restrain the tool positioning seat.

The end covers of early rail type tool racks were usually fixed, thus, in practical use, the users could not increase or reduce or change the tool positioning seat, which was inconvenient. Afterwards, related circles developed some combined end cover types accordingly.

There are several types of the known structure of said combined end cover, but there are still some problems in practical application. For example, one of the known combined end covers is inserted in the socket formed at the end of railroad shoe and fixed by adhesives. The problem in this known type is that the combined end cover is fixed and nonremovable, causing inconvenience in the future. Another known combined end cover uses an elastic buckle block, the elastic buckle block is embedded in a slot opening in the seat surface of railroad shoe when the combined end cover is in combined state, and there is a release press button adjacent to the elastic buckle block, so that the user can disengage the elastic buckle block from the slot opening by pressing the release press button, and the combined end cover can be disengaged from the railroad shoe. However, this known combined end cover is complained for that the release press button is usually located in a relatively large region of end cover for convenient operation, but this position is usually the area of rail type tool rack gripped by the user's hand, it is likely to be pressed by accident to release the end cover by mistake. In practical application of the rail type tool rack, the user is little probably to disassemble or assemble the combined end cover. Therefore, the probability of said releasing the end cover by mistake induced by pressing the release press button by accident is too high, increasing the user's concerns in vain.

### BRIEF SUMMARY OF THE INVENTION

The primary object of the present invention is to provide a rail type tool rack, the technical problem to be solved is to break through how to develop a novel rail type tool rack with more ideal practicability, the combined end cover thereof can be assembled and combined easily.

Based on said object, the technical characteristic of problem solving of the present invention is that the rail type tool rack comprises a track, at least one tool positioning seat and two combined end covers, each tool positioning seat is provided with two gripping legs arranged symmetrically. The track is a long extended type, comprising an intermediate plate, two lateral grooves and two ends symmetrically connected to two opposite sides of intermediate plate. The lateral grooves are oppositely defined to form two side wall edges arranged vertically and a side opening between the outer sides of two side wall edges, and the two gripping legs of each tool positioning seat grip the outer side of the corresponding side wall edge, there is a through hole near each end of intermediate plate, penetrating the thickness of intermediate plate. Each combined end cover comprises a main body, an end limit block, two side claws and a bump. The main body comprises an abutting surface, two lateral sides and one end side. The abutting surface abuts against the outer wall surface of a side wall edge of the track. The end limit block is a block protruding downwards near the end side from the abutting surface, and the end limit block abuts on the corresponding end of track. The two side claws are two elastic undercuts protruding downwards near the two lateral sides from the abutting surface, and the two side claws grip the outer side of the corresponding side wall edge of track respectively. The bump is a block protruding downwards in the position between two side claws from the abutting surface, and the bump is embedded in the corresponding through hole of the intermediate plate for the track.

In terms of main effects and advantages of the present invention, with the specific architecture of the rail with an intermediate plate and two lateral grooves oppositely defined to form two side wall edges and a side opening, a combined end cover structure type convenient for assembling with excellent stability in combined state is provided. When said combined end cover is combined with the end of track, the two side claws of combined end cover grip the outer sides of side wall edges of track respectively. The bump is embedded in the through hole of intermediate plate of track. The end limit block hooks the track end, so that the combined end cover in combined state can be positioned in X, Y and Z directions, resulting in excellent firmness in combined state, preventing arbitrary drop-off. To assemble the combined end cover in the track end, as the side claws and end limit block have moderate ductility, the combination can be finished quickly as long as the user applies a little force.

Another object of the present invention is to provide another technical feature that a chamfer angle is provided on each side edge of the downward protruding end of the bump, so as to achieve the advantage and practical progressiveness that the bump can be easily stuck in the through hole of intermediate plate based on the morphological feature of chamfer angle.

Another object of the present invention is to provide another technical feature as the thickness of the intermediate plate defines a first thickness, a second thickness is defined between the outer wall surfaces of the two side wall edges, the second thickness is larger than the first thickness, so that the intermediate plate surface is a concave surface in relation to the outer wall surfaces of two side wall edges, and the thickness of intermediate plate is smaller than the thickness formed by the outer wall surfaces of two side wall edges, so as to achieve such advantages and practical progressiveness as material removal, equal thickness and saving material cost.

Another object of the present invention is to provide another technical feature as the end limit block is provided with two stilts arranged apart for connecting the abutting surface, a hollow part is formed between two stilts, the hooking width of end limit block coordinates with the width of intermediate plate, so that the end limit block has such advantages as wide firmness, material removal and saving material cost, and the end limit block exactly hooks the concave intermediate plate, further enhancing the firmness of hooking state.

### BRIEF DESCRIPTION OF THE SEVERAL VIEWS OF THE DRAWINGS

FIG. 1 is the combined stereogram of the preferred embodiment of the present invention.

FIG. 2 is the exploded view of partial components in the preferred embodiment of the present invention.

FIG. 3 is the stereogram from another view angle of the combined end cover of the present invention.

FIG. 4 is the top view of combined state of partial components in the preferred embodiment of the present invention.

FIG. 5 is the 5-5 sectional view of FIG. 4.

FIG. 6 is the 6-6 sectional view of FIG. 4.

FIG. 7 shows another embodiment of the end limit block of the present invention.

### DETAILED DESCRIPTION OF THE INVENTION

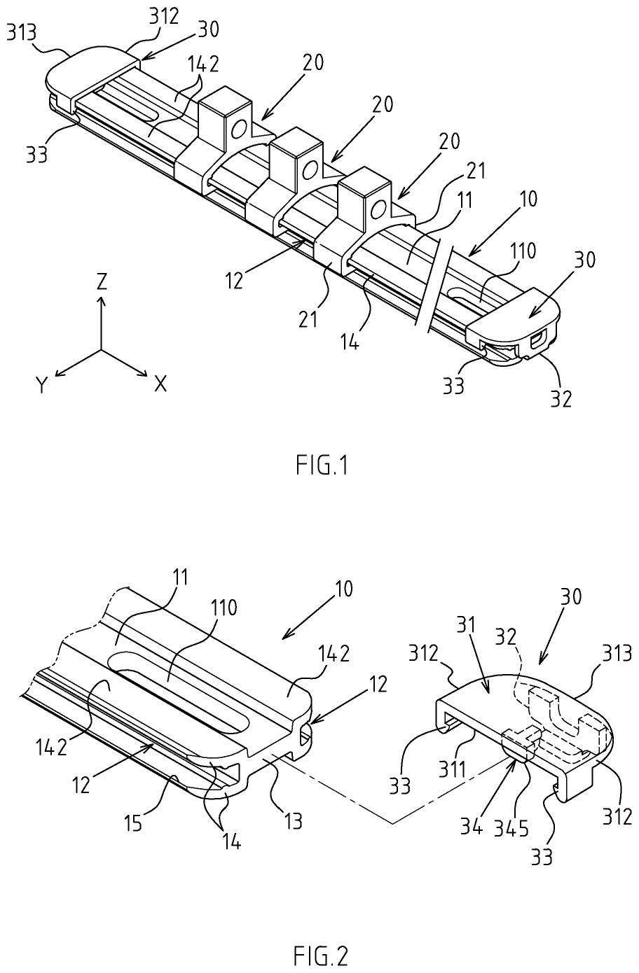

FIGS. 1 to 6 show the preferred embodiments of the rail type tool rack of the present invention, but the embodiments are for illustration only, the patent application is not limited to this structure.

Said rail type tool rack A comprises a track 10 (can be but not limited to aluminum product extrusion molding), at least one tool positioning seat 20 (plastic material is preferred) and two combined end covers 30 (plastic material is preferred). The tool positioning seat 20 is provided with two gripping legs 21 arranged symmetrically; wherein the track 10 is long extended type, comprising an intermediate plate 11, two lateral grooves 12 symmetrically connected to two opposite sides of the intermediate plate 11 and two ends 13. The lateral grooves 12 are oppositely defined to form two side wall edges 14 arranged vertically and a side opening 15 between the outer sides of the two side wall edges 14, and the two gripping legs 21 of the tool positioning seat 20 hook the outer side of the corresponding side wall edge 14, and there is a through hole 110 near each end 13 of the intermediate plate 11, penetrating the thickness of the intermediate plate 11. Wherein the combined end cover 30 comprises a main body 31, an end limit block 32, two side claws 33 and a bump 34. The main body 31 comprises an abutting surface 311, two lateral sides 312 and one end side 313. The abutting surface 311 abuts against the outer wall surface 142 of a side wall edge 14 of the track 10. The end limit block 32 is a block protruding downwards near the end side 313 from the abutting surface 311, and the end limit block 32 abuts on an end 13 of the track 10. The two side claws 33 are two elastic undercuts protruding downwards near the two lateral sides 312 from the abutting surface 311, and the two side claws 33 grip the outer side of the corresponding side wall edge 14 of the track 10. The bump 34 is a block protruding downwards in the position between the two side claws 33 from the abutting surface 311, and the bump 34 is embedded in the through hole 110 of intermediate plate 11 of the track 10.

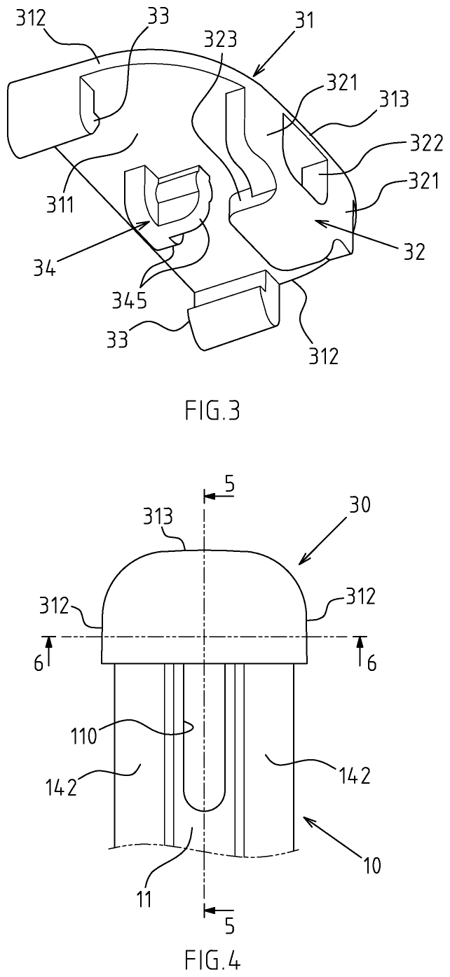

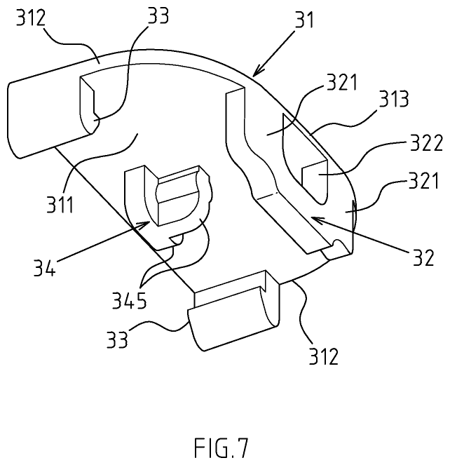

As shown in FIG. 3, in this case, the downward protruding end of the end limit block 32 is provided with an undercut part 323, the undercut part 323 abuts against the corresponding part of the intermediate plate 11 (as shown in FIG. 5). In this case, the undercut part 323 creates the positioning effect of end limit block 32 in one more direction. The downward protruding end of the end limit block 32 without the undercut part 323 is shown in FIG. 7, which can be a specific implementation pattern.

Based on the aforesaid structural composition and technical characteristics, the rail type tool rack A disclosed in the present invention, in the specific morphological architecture of the track 10 with said intermediate plate 11, two lateral grooves 12 oppositely defined to form two side wall edges 14 and a side opening 15, a combined end cover 30 structure type convenient for assembling with extra firmness in combined state is provided. When said combined end cover 30 is combined with the end 13 of track 10, as shown in FIGS. 4 to 6 (note: please refer to the axis marks in FIG. 1 for description of axial direction), wherein the two side claws 33 of combined end cover 30 grip the outer sides of the corresponding side wall edges 14 of track 10 respectively, so as to implement positioning action in Y and Z directions. The bump 34 is embedded in the through hole 110 of intermediate plate 11 of track 10, this part implements the Y-axis positioning action. The end limit block 32 abuts on the end 13 of track 10, this part implements X-axis positioning action. To sum up, the combined end cover 30 of in the present invention combined with the end 13 of track 10 can implement the positioning actions in X, Y and Z directions, so it has extra firmness in combined state, the known problem of arbitrary drop-off of combined end cover 30 will not occur though the user's hand grips or presses the combined end cover 30. To assemble the combined end cover 30 in the end 13 of track 10, the bump 34 can be stuck in the through hole 110 of intermediate plate 11 of track 10, meanwhile as the side claws 33 and end limit block 32 have moderate ductility, the combination can be done quickly as long as the user applies a little force (Note: please refer to the variation between the construction line contour and solid line contour of combined end cover 30 disclosed in FIG. 5).

As shown in FIG. 3, in this case, the section of the bump 34 is T-shaped, and each side edge of the downward protruding end of the bump 34 is provided with a chamfer angle 345. The main effect of the implementation pattern disclosed in this case is to use the morphological feature of the chamfer angle 345 to make the bump 34 easier to be stuck in the through hole 110 of intermediate plate 11.

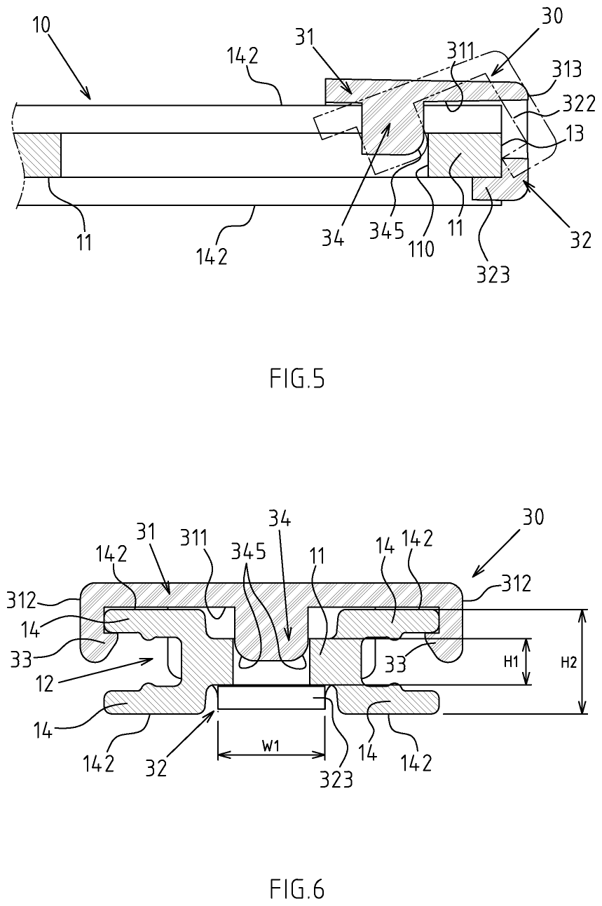

As shown in FIG. 6, in this case, the thickness of the intermediate plate 11 defines a first thickness H1, a second thickness H2 is defined between the outer wall surfaces 142 of the two side wall edges 14, wherein the second thickness H2 is larger than the first thickness H1, so that the surface of the intermediate plate 11 is a concave surface in relation to the outer wall surface 142 of the two side wall edges 14. The benefit of the implementation pattern disclosed in this case is that the thickness of intermediate plate 11 is smaller than the thickness formed by the outer wall surface 142 of two side wall edges 14, the advantages include material removal, equal thickness and saving material cost.

As shown in FIG. 3, in this case, the end limit block 32 is provided with two stilts 321 arranged apart for connecting the abutting surface 311, the two stilts 321 are oppositely defined to form a hollow part 322, as shown in FIG. 6, the hooking width of the end limit block 32 (W1) coordinates with the width of the intermediate plate 11. The benefit of the implementation pattern disclosed in this case is that the end limit block 32 has wide firmness, material removal and saving material cost, and the end limit block 32 exactly hooks the concave intermediate plate 11, further enhancing the firmness in hooking state (Note: increasing Y-axis positioning action).

I claim:

1. A rail type tool rack comprises a track, at least one tool positioning seat and two combined end covers; the tool positioning seat is provided with two gripping legs arranged symmetrically; wherein the rail is a long extended type, including an intermediate plate, two lateral grooves and two ends symmetrically connected to two opposite sides of the intermediate plate; the lateral grooves are oppositely defined to form two side wall edges arranged vertically and a side opening between the outer sides of the two side wall edges, and the two gripping legs of the tool positioning seat hook the outer sides of the corresponding side wall edges, the intermediate plate is provided with a through hole near each end, penetrating the thickness of the intermediate plate; the combined end cover comprises a main body, an end limit block, two side claws and a bump; the main body comprises an abutting surface, two lateral sides and one end side; the abutting surface abuts against the outer wall surface of a side wall edge of the track; the end limit block is a block protruding downwards near the end side from the abutting surface, and the end limit block abuts on one end of the track; the two side claws are two elastic undercuts protruding downwards near the two lateral sides from the abutting surface, and the two side claws grip the outer sides of the corresponding side wall edges of the track respectively; the bump is a block protruding downwards between the two side claws from the abutting surface, and the bump is embedded in the through hole of the intermediate plate of the track.

2. The rail type tool rack defined in claim 1, wherein the section of the bump is T-shaped, and each side edge of the downward protruding end of the bump is provided with a chamfer angle.

3. The rail type tool rack defined in claim 2, wherein the thickness of the intermediate plate defines a first thickness, a second thickness is defined between the outer wall surfaces of the two side wall edges, wherein the second thickness is larger than the first thickness, so that the surface of the intermediate plate is a concave surface in relation to the outer wall surface of the two side wall edges.

4. The rail type tool rack defined in claim 3, wherein the downward protruding end of the end limit block is provided with an undercut part, the undercut part abuts against the corresponding part of the intermediate plate.

5. The rail type tool rack defined in claim 4, wherein the end limit block is provided with two stilts arranged apart for connecting the abutting surface, the two stilts are oppositely defined to form a hollow part, and the hooking width of the end limit block coordinates with the width of the intermediate plate.
